(19) United States
(12) Patent Application Publication
(10) Pub. No.: US 2008/0159819 A1
(43) Pub. Date: Jul. 3, 2008

(54) EDGE FINISHING SYSTEM

(76) Inventors: Bien Trong Bui, Howell, MI (US); Eric F.J.M. Van Der Meulen, Wixom, MI (US)

Correspondence Address: EXATEC;C/O BRINKS HOFER GILSON & LIONE, P. O. BOX 10395, CHICAGO, IL, 60610, US

(21) Appl. No.: 11/964,833

(22) Filed: Dec. 27, 2007

Related U.S. Application Data
(60) Provisional application No. 60/882,293, filed on Dec. 28, 2006.

(51) Int. Cl. B23B 27/06; B23Q 3/00

(52) U.S. Cl. 407/42; 408/76; 408/21

(57) ABSTRACT

An edge finishing system for items such as polycarbonate panels. The system includes a multi-purpose edge-finishing tool which trims and smoothes the edges of a workpiece. The tool includes a contour cutter portion having a concave toroidal surface and a straight cutter portion having a cylindrical shape. A flute extends generally along with the tool's axis and defines a straight cutting edge and contour cutting edge. The system may include a fixture with vacuum cups nested within a platform so as to secure a contoured workpiece by static friction, permitting edges of the workpiece to be both trimmed and smoothly finished using a multi-purpose edge finishing tool, without marring or disfiguring the surface of the workpiece.

This application claims priority to U.S. provisional application 60/882,293, filed Dec. 28, 2006.

### BACKGROUND OF THE INVENTION

Items made of plastic, polycarbonate, and similar resin-based compounds are typically formed and manufactured using injection molding, vacuum forming, or blow molding techniques. Parts produced by such molds frequently have edges that require further finishing work, including cutting or trimming tabs projecting from the edge of the molded part, trimming rough or irregular portions, smoothing the edges to make them less rough, and smoothing the edges to make a convex or rounded edge.

Removal of unwanted portions of molded parts is commonly performed by placing the workpiece in a fixture and then using a high speed rotary cutting tool having a straight cutting edge, or lip, parallel to the rotary axis and formed in a generally cylindrical cutting tool. Forming a smooth, rounded convex edge on the finished part ordinarily employs the same fixture but a differently shaped tool, having a cutting edge formed in a concave surface sized to produce the desired convex edge of the finished piece.

Where both tasks are required, trimming and edge-shaping, the operator must exchange tools within the rotary power source. Multiple tools require an operator to run batches of product through with each tool, or require the operator to remove and exchange a straight cutter tool with a contour cutter tool for every piece. These inefficiencies are exacerbated when a large volume of pieces require finishing at close tolerance levels, including situations where the finishing process is performed by computer aided manufacturing techniques, e.g., using a robot to position and guide the tools.

Further, when finishing the edge of a panel of plastic or polycarbonate, it is important to hold the workpiece firmly to prevent “chattering,” to maximize unencumbered access to the edges, and to minimize marring or disfiguring the panel. Additional challenges are presented when a non-planar panel is to be secured in a fixture in preparation for edge finishing work.

### BRIEF SUMMARY OF THE INVENTION

An edge finishing system utilizing a fixture and an edge finishing tool is claimed. In one embodiment, the workpiece is held in a fixture while its edges are finished by a multi-purpose tool comprising a cylindrical shank insertable into a rotary power source, a contour cutter portion having a concave surface interrupted by at least one cutting edge, and a straight cutter portion having a generally cylindrical surface interrupted by a straight cutting edge. In one embodiment of the multi-cutter tool, at least one flute extends continuously from the straight cutter portion and through the contour cutter portion, with the edge of the flute defining the cutting edge or lip of the two portions. The flute can be substantially longitudinal and parallel with the axis of the tool, or it could be skew or helical to the axis. In one embodiment, a shoulder portion is disposed between the shaft portion and contour cutter portion to engage the end of a rotating collet and to positively limit insertion.

The system includes a fixture for securing the workpiece, which in one embodiment includes a platform contoured to receive a smooth surface of the workpiece, the platform comprising a plurality of vacuum elements arranged within the platform and structured to engage and secure by static friction the smooth surface of the workpiece firmly against the platform. In another embodiment, the edges of the workpiece are advantageously exposed to permit a multi-cutter tool, for example, to finish the workpiece edges. The system permits a human operator or robot to perform straight cutting of edges as well as cutting and finishing of rounded convex edges without changing tools or repositioning the workpiece in a fixture, and permits the workpiece to be firmly secured in a manner that permits unobstructed access to workpiece edges and which minimizes marring or disfiguring the workpiece.

### BRIEF DESCRIPTION OF THE DRAWINGS

FIG. 1 is a side view of a multi-cutter tool having a straight longitudinal flute forming the cutting edges of a straight portion and a contour portion;

FIG. 2 is an end view from the lower end of the cutting tool shown in FIG. 1;

FIG. 3 is a side view of a cutting tool having a helical flute forming the cutting edges of the straight and contour portions;

FIG. 4 Is a top view of one embodiment of a fixture employable with the system ; and

FIG. 5 is a diagrammatic sectional view, generally taken along line 5-5, of the fixture shown in FIG. 4.

### DETAILED DESCRIPTION OF THE INVENTION

The following description of preferred embodiments is merely exemplary in nature and is in no way intended to limit the invention or its application or uses.

The present invention is a system for holding a workpiece in a fixture and finishing its edges. In one embodiment a multi-cutter tool is used in combination with a rotary power source to cut or trim materials, including approximately planar materials requiring a relatively smooth straight edge or a rounded convex edge. For example, polycarbonate panels, including optically clear polycarbonate glazing (i.e., windows) installed in motor vehicles, typically require trimming and finishing of edges prior to installation. The molding process for polycarbonate panels typically results in a panel having one or more tabs used for handling, and perhaps one or more “gates” through which the resin was injected into the mold. These projections must be trimmed prior to installation. Additionally, the edges of molded panels may require rounding and smoothing, typically to match the surface contour and appearance of areas where tabs and gates were removed. In a polycarbonate automobile glazing, the perimeter edge is typically finished as a relatively smooth rounded surface. A tool attached to a rotary power source is ordinarily used for such operations, with a straight edge rotary tool used to trim unwanted projections or cut away oversized portions, and a concave-shaped rotary tool used to create the rounded peripheral edge.

FIG. 1 shows a multi-cutter tool 10 incorporating both a straight cutter portion 12 and a contour cutter portion 14. A shank 16 is cylindrical and inserts into a collet or chuck of a rotary power source. Beneath shank 16 is a shoulder 18 having a larger diameter than shank 16. Shoulder 18 is configured to engage the exterior surface of the collet, thereby serving as an insertion limit into the collet and permitting reliable set up dimensions for robotically programmed operations, including operations where the workpiece is held in a suitable fixture which consistently positions the workpiece with respect to the robot.

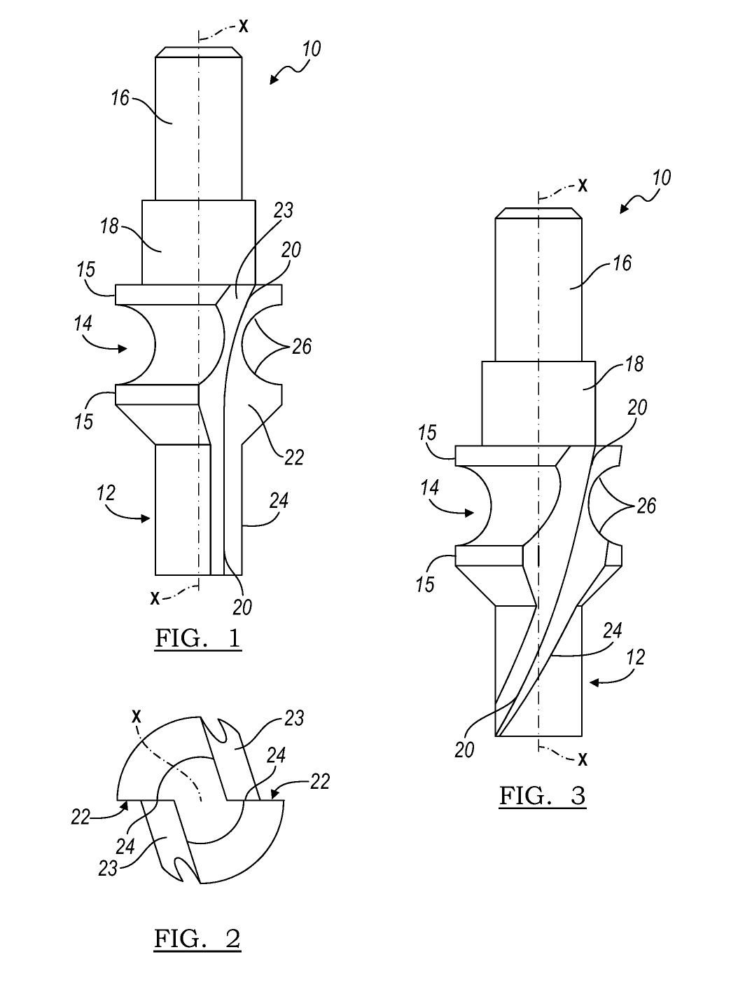

Contour portion 14 generally comprises a concave toroidal surface, between two lands 15, centered on an axis X extending longitudinally through the tool 10. Straight cutter portion 12 is located adjacent cutter portion 14 (separated by a tapered portion), and is cylindrical in shape. The circumferential surfaces of both contour cutter portion 14 and straight cutter portion 12 are interrupted by at least one cutting edge formed in the concave toroidal surface and cylindrical surface of these respective portions. In one embodiment, the cutting edge is formed by a flute 20 machined into the surfaces. The tool 10 shown in FIGS. 1 and 2 includes two diametrically opposed flutes 20. Each flute comprises at least one planar portion 22 cut or ground into the toroidal and cylindrical surfaces of the contour cutter portion 14 and straight cutter portion 12, respectively. As shown in FIGS. 1 and 2, planar portion 22 extends longitudinally along a plane substantially congruent with axis X. Flute 20 is further defined by a flute surface portion 23 which opposes planar portion 22. In the embodiment shown, flute surface portion 23 is nonplanar and substantially perpendicular to planar portion 22.

The intersection of the cylindrical surface of straight cutter portion 12 with the planar portion 22 of flute 20 defines a cutting edge or lip 24 on straight cutter portion 12. Similarly, planar portion 22 of flute 20 defines a contour cutting edge 26 on contour cutter portion 14.

A rapidly rotating multi-cutter tool 10, e.g. 30,000-50,000 rpm, can thus engage with the edge of a workpiece at its straight cutter portion 12 to cut away panel portions and to trim unwanted tabs. An operator (including a robot or machine programmed to perform the task) can guide the rotating tool around the entire perimeter of the workpiece. After trimming, with the straight cutter portion 12, the operator can simply translate the tool slightly along the axis X, then travel the same perimeter path a second time to create a smooth convex edge using contour cutter portion 14. The embodiments herein disclosed produce a reasonably smooth edge requiring no further sanding or smoothing for typical applications.

Multi-cutter tool may be of unitary construction of a metal or metal alloy such as tungsten carbide. Alternatively, multi-cutter tool 10 may have cutting edges comprising diamonds in the straight cutter portion 12 and/or the contour cutter portion 14. Further, the tool may be coated with a titanium coating in order to reduce operation temperatures and extend the service life of the tool by maintaining sharp cutting edges 24 and 26. Although FIGS. 1 and 2 show two flutes 20 formed in multi-cutter tool 10, depending on the application, a single flute defining a single cutting edge or three or more flutes with multiple cutting edges might be appropriate. Further, it will be appreciated that the axial positions along the tool 10 of straight cutter portion 12 and contour cutter portion 14 could be reversed.

In the embodiment shown, flute 20 extends continuously from straight cutter portion 12 into contour cutter portion 14. However, flute 20 may be discontinuous between straight cutter portion 12 and contour cutter portion 14. Additionally, the portion of the flute 20 in the straight cutter portion 12 may be circumferentially offset from the portion of the flute 20 in the contour cutter portion 14.

FIG. 3 illustrates another embodiment of the invention showing flute 20 formed on multi-cutter tool 10 in a helical fashion. Flute 20 could also be formed on multi-cutter tool in an angled planar fashion, orienting flute plane 22 skew to axis X, roughly approximating the gradual helix illustrated in FIG. 3. By angling cutting edges 24 and 26 in this fashion, it may be possible to realize certain advantages such as longer service life and improved directional control over the material removed by multi-cutter tool 10. (“Straight cutting edge” as used herein and in the claims refers to the cutting edge on the straight cutter portion 12.)

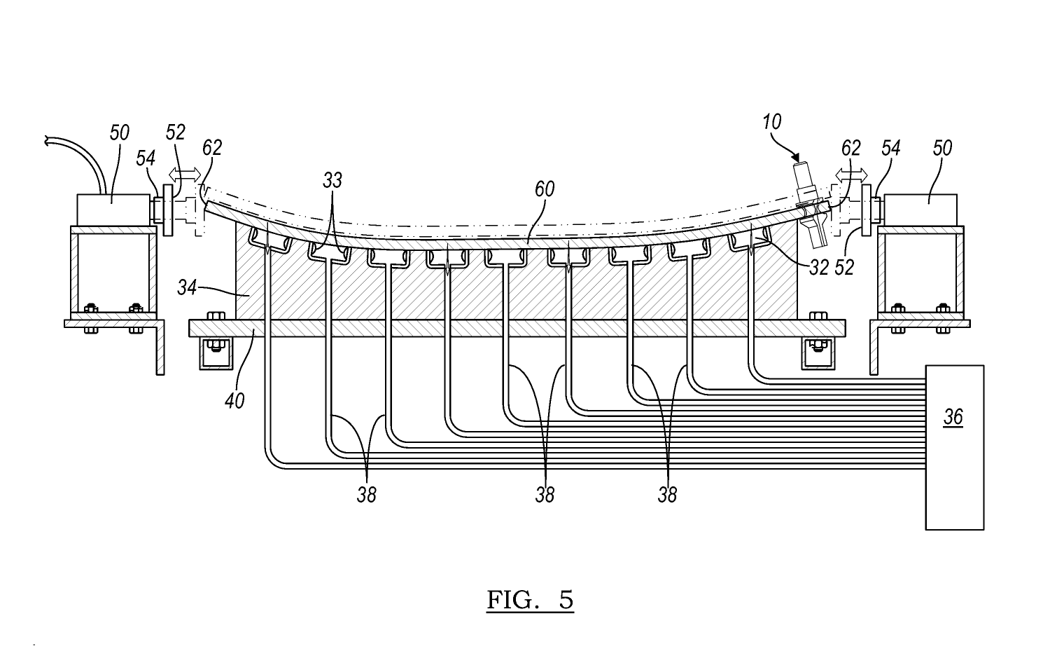

In another aspect of the invention, a tool, for example a multi-cutter tool 10, is used to finish portions of a workpiece 60 held within a vacuum assisted fixture 30. Fixture 30 is primarily comprised of a plurality of vacuum elements such as vacuum cups 32, nested within a contour platform 34. In one application, workpiece 60 could be a clear polycarbonate panel having a curved contour across one or two of its near-planar dimensions, as shown in FIG. 5. A plurality of vacuum cups 32 are nested within contour platform 34 in appropriate placement and number to firmly secure a smooth surface of workpiece 60 against a corresponding contoured surface of contour platform 34 upon actuation of a vacuum source 36. Thus, contour platform 34 is designed to complimentarily engage the smooth contoured surface of workpiece 60. Preferably, contour platform 34 is comprised of a non-marring, non-slip surface such as a polyurethane material. In the embodiment shown, the polyurethane material monolithically forms contour platform 34. Contour platform 34 is also sufficiently rigid to withstand pressures exerted by the interaction between the workpiece 60 and vacuum cups 32, which are under negative pressure (vacuum) generated by vacuum source 36 and applied to vacuum cups 32 by means of one or more vacuum lines 38. In a preferred embodiment, each vacuum cup 32 has a bellows portion 33 and is arranged within contour platform 34 such that a portion of the bellows of vacuum cup 32 engages a smooth surface of workpiece 60 and collapses upon vacuum actuation to slightly below the surface of contour platform 34, thereby ensuring a tight and secure engagement between workpiece 60 and contour platform 34.

Contour platform 34 may have an engagement surface that is smaller in area than the smooth side of workpiece 60. Such a design permits a tool, such as the multi-cutter edge finishing tool 10, to perform work on the edges of workpiece 60 unhindered by fixture components. It is to be understood, however, that contour platform 34 could be configured to have an outer perimeter which extends beyond workpiece 60 in one or more planar dimensions, for example, if one or more edges required no finishing work.

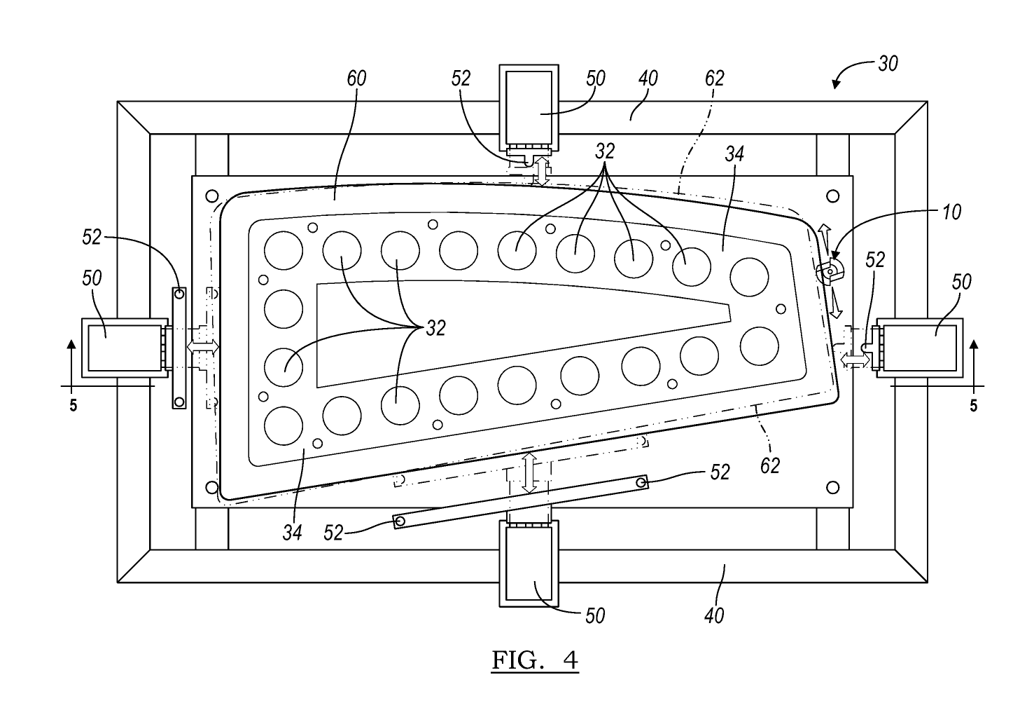

In the embodiment shown in FIGS. 4 and 5, contour platform 34 is secured to base 40, which is comprised of a rigid metal such as aluminum or steel. Attached to base 40, and arranged around the perimeter of the workpiece 60, are a plurality of workpiece positioners 50 having contact surfaces 52 at the end of a retractable piston 54. In one embodiment, workpiece positioners 50 are pneumatically powered and can be adjusted to extend and retract with a high degree of reliability and precision.

In operation, a workpiece 60 is placed in an approximate location upon contour platform 34. Workpiece positioners 50 are then pneumatically activated to extend pistons 54 to a precise predetermined position so as to engage contact surfaces 52 with engagement areas on edges 62 of workpiece 60, thereby positioning the workpiece 60. After workpiece 60 is so positioned, vacuum source 36 is actuated, resulting in negative air pressure through vacuum tubes 38 and vacuum cups 32. The negative pressure collapses the bellows 33 and causes workpiece 60 to be drawn tightly against contour platform 34 with sufficient static friction to secure workpiece 60 against movement relative to fixture 30.

So secured, the system permits workpiece 60 to be worked upon by a tool such as multi-cutter tool 10. A robot may direct a rapidly spinning multi-cutter tool 10 around the perimeter edge 62 of workpiece 60 in two passes, whereby the first pass is used to cut or trim edge 62 of unwanted material using the straight cutter portion 12 of multi-cutter tool 10. The robot then translates multi-cutter tool 10 along axis X and repeats substantially the same pass, this time applying contour cutter portion 14 of the tool 10 against edge 62 of workpiece 60 to finish the edge. The embodiment shown permits these edges to be finished free from workpiece movement or chatter and without marring or disfiguring workpiece 60 at the points where it contacts fixture 30.

While the above description constitutes one or more embodiments of the present invention, it will be appreciated that the invention is susceptible to modification, variation and change without departing from the proper scope and fair meaning of the accompanying claims.

1. An edge finishing system, comprising a multi-purpose edge-finishing tool for performing work on a workpiece, said tool comprising a cylindrical shank centered about an axis and insertable into a rotary power source, the tool including a contour cutter portion comprising a concave toroidal surface centered about the axis and interrupted by at least one contour cutting edge, the tool also including a straight cutter portion comprising a cylindrical surface centered about the axis and interrupted by at least one straight cutting edge.

2. The edge finishing system of claim 1 wherein the contour cutting edge is defined by a flute formed within the toroidal surface.

3. The edge finishing system of claim 2 wherein the flute is at least partially defined by a planar surface substantially congruent with the axis.

4. The edge finishing system of claim 2 wherein the flute is at least partially defined by a plane which is skew to the axis.

5. The edge finishing system of claim 2 wherein the flute is at least partially defined by a curved surface which is helical relative to the axis.

6. The edge finishing system of claim 2 wherein the contour cutting edge further comprises diamonds.

7. The edge finishing system of claim 1, further comprising a shoulder having a larger diameter than the shank and located between the shank and the contour cutter portion and configured to engage with a collet or chuck.

8. The edge finishing system of claim 1 wherein the straight cutting edge is defined by a flute formed within the cylindrical surface.

9. The edge finishing system of claim 8 wherein the flute is at least partially defined by a planar surface substantially congruent with the axis.

10. The edge finishing system of claim 8 wherein the flute is at least partially defined by a planar surface that is skew to the axis.

11. The edge finishing system of claim 8 wherein the flute is at least partially defined by a curved surface that is helical relative to the axis.

12. The edge finishing system of claim 8 wherein the straight cutting edge further comprises diamonds.

13. The edge finishing system of claim 1, further comprising two diametrically opposed flutes each defining at least one of the contour cutting edge and the straight cutting edge.

14. The edge finishing system of claim 1 wherein the contour cutting edge and the straight cutting edge are defined by a common flute extending continuously between the contour cutter portion and the straight cutter portion.

15. The edge finishing system of claim 1 wherein the tool is of unitary construction.

16. The edge finishing system of claim 1 further comprising a fixture for securing the workpiece.

17. An edge finishing system, comprising:
a fixture for securing a workpiece; and
a multi-purpose edge finishing tool for performing work on the workpiece secured by the fixture, said tool comprising a cylindrical shank centered about an axis and insertable into a rotary power source; the tool including a contour cutter portion comprising a concave toroidal surface centered about an axis and having a flute formed within the toroidal surface defining a contour cutting edge; the tool further including a straight cutter portion comprising a cylindrical surface centered about the axis, the flute extending through the cylindrical surface and defining a straight cutting edge; wherein the flute extends continuously between the contour cutter portion and the straight cutter portion.

18. The edge finishing system of claim 17 wherein the flute is at least partially defined by a planar surface that is substantially congruent with the axis.

19. The edge finishing system of claim 17 wherein the flute is at least partially defined by a planar surface that is skew to the axis.

20. The edge finishing system of claim 17 wherein the flute is at least partially defined by a curved surface that is substantially helical relative to the axis.

21. The edge finishing system of claim 1 wherein the fixture comprises a plurality of vacuum elements nested within a contour platform, the vacuum elements and an engagement surface of the contour platform arranged to complementarily engage with a surface of the workpiece.

22. The edge finishing system of claim 21 wherein the engagement surface is smaller in area than the smooth side of the workpiece.

23. The edge finishing system of claim 21 further comprising a plurality of retractable workpiece positioners engageable with the workpiece.

24. The edge finishing system of claim 23 wherein the plurality of retractable workpiece positioners are extendable to engage with engagement areas of the workpiece and to position the workpiece relative to the contour platform, and are retractable to permit access to one or more of the engagement areas on the contour platform.

25. The edge finishing system of claim 24, wherein at least one of the plurality of retractable workpiece positioners is pneumatically operated.
